(19) United States
(12) Patent Application Publication
(10) Pub. No.: US 2025/0013924 A1
(43) Pub. Date: Jan. 9, 2025

(54) SYSTEMS AND METHODS FOR DYNAMIC DATA OPERATIONS MODELLING

(71) Applicant: ROYAL BANK OF CANADA, Toronto (CA)

(72) Inventors: Adam LAZURE, Brantford (CA); Rahul SIRIMANNA, Toronto (CA); Gabrielle DESJARDINS, Toronto (CA); Igor RESHYNSKY, Vaughan (CA); Chiu-Hua Vincent HUANG, Mississauga (CA)

(21) Appl. No.: 18/765,042

(22) Filed: Jul. 5, 2024

Related U.S. Application Data
(60) Provisional application No. 63/525,535, filed on Jul. 7, 2023.

(51) Int. Cl. G06N 20/00

(52) U.S. Cl. CPC G06N 20/00

(57) ABSTRACT

Systems and methods for dynamic data operations modeling. A system may include a processor and a memory storing processor-executable instructions that configure the processor to: retrieve, at time stages, a set of data records associated with meta attributes representing operations on the data records at stages over time; generate, at the respective time stages, a categorical prediction associated with the data operations based on a detection model and a set of meta attributes associated with the retrieved data records, the detection model based on a multinomial logistic regression providing the categorical prediction for adapting multi-label predictions; and transmit, following the successive time stages, one or more signals representing the categorical prediction for dynamically updating the user interface for communicating an interim categorical prediction during data operations execution.

### CROSS-REFERENCE TO RELATED APPLICATION

This application claims the benefit of and priority from U.S. Provisional Patent Application No. 63/525,535 filed Jul. 7, 2023, the entire content of which is herein incorporated in its entirety by reference.

### FIELD

Embodiments of the present disclosure generally relate to data operations modelling, and in particular to systems and methods for dynamic data operation modeling to assist with a variety of system audits.

### BACKGROUND

Data management servers may be configured to retrieve volumes of data sets from a plurality of data sources and may conduct data operations on data records of data sets. In some examples, data records may be associated with meta attributes representing operations on the data records over time.

### SUMMARY

In accordance with example embodiments described herein, a system for dynamic data operation modeling is implemented to generate predictions associated with dynamic operations and may further generate graphical user interface elements to aid with users in real time regarding one or more types of different operations based on user input.

In one aspect, there is described a system for dynamic data operations modeling, the system including: a processor; and a memory coupled to the processor and storing processor-executable instructions that, when executed, configure the processor to: receive a set of data records associated with meta attributes representing operations on the data records, the operations performed over a sequence of time stages; generate, by a detection model at each respective time stage from the sequence of time stages, a categorical prediction associated with the data operations using the meta attributes, the detection model based on a multinomial logistic regression providing the categorical prediction for adapting multi-label predictions; and transmit, following the sequence of time stages, one or more signals representing one or more from the categorical predictions for dynamically updating the user interface for communicating an interim categorical prediction during data operations execution.

In some embodiments, the detection model is based on a set of model features considered for the categorical prediction, wherein the processor is configured to: train the detection model by determining one or more regression coefficients based on odds ratio among for respective model features.

In some embodiments, the processor is configured to determine statistical association among respective multi-label predictions for excluding at least one model feature from training the detection model.

In some embodiments, the sequence of time stages are at non-periodic time intervals.

In some embodiments, the processor is configured to: determine variance inflation factors for generating class weights to associate with respective multi-label predictions.

In some embodiments, the detection model is based on an ordinal regression for determining variance inflation factors.

In some embodiments, the multi-label predictions includes a satisfactory, a require improvement, or an unsatisfactory prediction.

In some embodiments, the processor is configured to: receive user input representing an audit type; generate a first set of features based on the set of data records using feature engineering; transmit the first set of features to the detection model; and generate, by the detection model at each respective time stage from the sequence of time stages based on the first set of features, the categorical prediction associated with the data operations using the meta attributes.

In some embodiments, the processor is configured to: receive a second user input representing a second audit type; generate a second set of features based on the set of data records using feature engineering; transmit the second of features to the detection model; and generate, by the detection model at each respective time stage from the sequence of time stages based on the second set of features, the categorical prediction associated with the data operations using the meta attributes.

In some embodiments, at least one of the first and second set of features are generated using large language model.

In another aspect, there is described a computer-implemented method for dynamic data operations modelling, the method includes: receiving a set of data records associated with meta attributes representing operations on the data records, the operations performed over a sequence of time stages; generating, by a detection model at each respective time stage from the sequence of time stages, a categorical prediction associated with the data operations using the meta attributes, the detection model based on a multinomial logistic regression providing the categorical prediction for adapting multi-label predictions; and transmitting, following the sequence of time stages, one or more signals representing one or more from the categorical predictions for dynamically updating the user interface for communicating an interim categorical prediction during data operations execution.

In some embodiments, the detection model is based on a set of model features considered for the categorical prediction, and the method comprises training the detection model by determining one or more regression coefficients based on odds ratio among for respective model features.

In some embodiments, the method includes determining statistical association among respective multi-label predictions for excluding at least one model feature from training the detection model.

In some embodiments, the method includes comprising determining variance inflation factors for generating class weights to associate with respective multi-label predictions.

In some embodiments, the detection model is based on an ordinal regression for determining variance inflation factors.

In some embodiments, the multi-label predictions includes a satisfactory, a require improvement, or an unsatisfactory prediction.

In some embodiments, the method may include: receiving user input representing an audit type; generating a first set of features based on the set of data records using feature engineering; transmitting the first set of features to the detection model; and generating, by the detection model at each respective time stage from the sequence of time stages based on the first set of features, the categorical prediction associated with the data operations using the meta attributes.

In some embodiments, the method may include: receiving a second user input representing a second audit type; generating a second set of features based on the set of data records using feature engineering; transmitting the second of features to the detection model; and generating, by the detection model at each respective time stage from the sequence of time stages based on the second set of features, the categorical prediction associated with the data operations using the meta attributes.

In some embodiments, the method may include: generating at least one of the first and second set of features using large language model.

A non-transitory computer-readable medium or media having stored thereon machine interpretable instructions which, when executed by a processor, cause the processor to perform a computer-implemented method of dynamic data operations modelling, the method comprising: receiving a set of data records associated with meta attributes representing operations on the data records, the operations performed over a sequence of time stages; generating, by a detection model at each respective time stage from the sequence of time stages, a categorical prediction associated with the data operations using the meta attributes, the detection model based on a multinomial logistic regression providing the categorical prediction for adapting multi-label predictions; and transmitting, following the sequence of time stages, one or more signals representing one or more from the categorical predictions for dynamically updating the user interface for communicating an interim categorical prediction during data operations execution.

In another aspect, the present disclosure provides a system comprising a processor and a memory coupled to the processor. The memory storing processor-executable instructions that, when executed, configure the processor to: retrieve, at time stages, a set of data records associated with meta attributes representing operations on the data records at stages over time; generate, at the respective time stages, a categorical prediction associated with the data operations based on a detection model and a set of meta attributes associated with the retrieved data records, the detection model based on a multinomial logistic regression providing the categorical prediction for adapting multi-label predictions; and transmit, following the successive time stages, one or more signals representing the categorical prediction for dynamically updating the user interface for communicating an interim categorical prediction during data operations execution.

In another aspect, the present disclosure provides a method of retrieving, at time stages, a set of data records associated with meta attributes representing operations on the data records at stages over time; generating, at the respective time stages, a categorical prediction associated with the data operations based on a detection model and a set of meta attributes associated with the retrieved data records, the detection model based on a multinomial logistic regression providing the categorical prediction for adapting multi-label predictions; and transmitting, following the successive time stages, one or more signals representing the categorical prediction for dynamically updating the user interface for communicating an interim categorical prediction during data operations execution.

In yet another aspect, a non-transitory computer-readable medium or media having stored thereon machine interpretable instructions which, when executed by a processor may cause the processor to perform one or more methods described herein.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### BRIEF DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a simplified block diagram showing a system for dynamic data operation modeling, in accordance with an embodiment of the present disclosure;

FIG. 2 Illustrates a block diagram of an example embodiment of a system for dynamic data operation modeling, in accordance with an embodiment of the present disclosure;

FIG. 3A illustrates an association plot illustrating a count of a first level of issues and ratings, in accordance with an embodiment of the present disclosure;

FIG. 3B illustrates an association plot illustrating a count of a second level of issues and ratings, in accordance with an embodiment of the present disclosure;

FIG. 4 illustrates an association plot illustrating a percentage of ineffectively designed controls and ratings, in accordance with an embodiment of the present disclosure;

FIG. 5 illustrates an association plot illustrating a percentage of controls with operation not met and ratings, in accordance with an embodiment of the present disclosure;

FIG. 6 illustrates an association plot illustrating a percentage of controls with operation partially met and ratings, in accordance with an embodiment of the present disclosure;

FIG. 7 illustrates a method for dynamic data operations modelling, in accordance with an embodiment of the present disclosure;

FIG. 8 illustrates a user interface for displaying categorical predictions during data operations execution, in accordance with an embodiment of the present disclosure;

FIG. 9 illustrates a partial, enlarged user interface for displaying categorical predictions during data operations execution, in accordance with an embodiment of the present disclosure;

FIG. 10 illustrates the partial, enlarged user interface of FIG. 9 at a subsequent point in time;

FIG. 11 illustrates an example showing various p-values associated with each predictor variable and an associated audit rating;

FIG. 12 illustrates an example op-value using Pearson's Chi-squared test;

FIGS. 13 and 14 each illustrates a respective example table listing class specific accuracies; and

FIG. 15 illustrates another example with various predictor values in an example embodiment.

### DETAILED DESCRIPTION

Embodiments of systems and methods for dynamic data operations modelling are described in the present disclosure.

Example operations may include data operations performed on one or more raw or processed data records. A data record can include one or more data structures; a data structure can include one or more data fields, and each data field may correspond to a data type. Metadata attributes, or simply “meta attributes”, can be used for defining and describing different data types or other types of information regarding the data fields in a data structure or a data record.

In some scenarios, systems may be configured with hard-coded, rules-based operations for predicting whether data operations on the set of data records adhere to example data record accuracy or data record completeness criteria. Such hard-coded, rule-based operations may be defined by decision tree models. Example decision tree models may be developed based on years of expert experience and based on manual canvas by an auditor user of voluminous sets of data records.

Over time, the above-described hard-coded, rules-based decision tree models may not be representative of evolving organizational policies relating to data record accuracy or data record completeness criteria. In some scenarios, updates to or alterations to hard-coded, rules-based decision tree models may require manual processes by expert users based on time-intensive, laborious canvas of voluminous sets of data record.

It may be desirable to provide systems and methods for dynamic data operations modeling for generating predictions on whether data operations conducted on sets of data records adhere to organizational policies, such as policies relating to data record accuracy or data record completeness, among other example criteria.

In some scenarios, it may be desirable to provide systems and methods for generating interim predictions on data operations adherence to organizational policies in parallel with execution of data operations on volumes of data records. By generating interim predictions in substantially real-time and in parallel with execution of data operations, a client device may display benchmarking data for assessing actual data operations on data records against expect (predicted) data operations based on detection models trained based on data records of prior time.

In some embodiments, systems may be configured with detection models including multinomial logistic regression models. The example detection models may be trained based on audit user control test outcomes, prior-identified issues, or prior-identified issue levels, among other example training data set data, for generating interim predictions on data operations adherence to a set of redefined metrics or rules. In some embodiments, the detection models may be based on prior-identified trends, statistical measures, or other status quo metrics associated with data records from prior points in time. In some embodiments, the detection models may be continually trained and update for identifying organizational abnormalities recorded among data records, such as potentially un-scrutinized, erroneous, inaccurate, or fraudulent data records, among other examples. Examples of various embodiments will be described in the present disclosure.

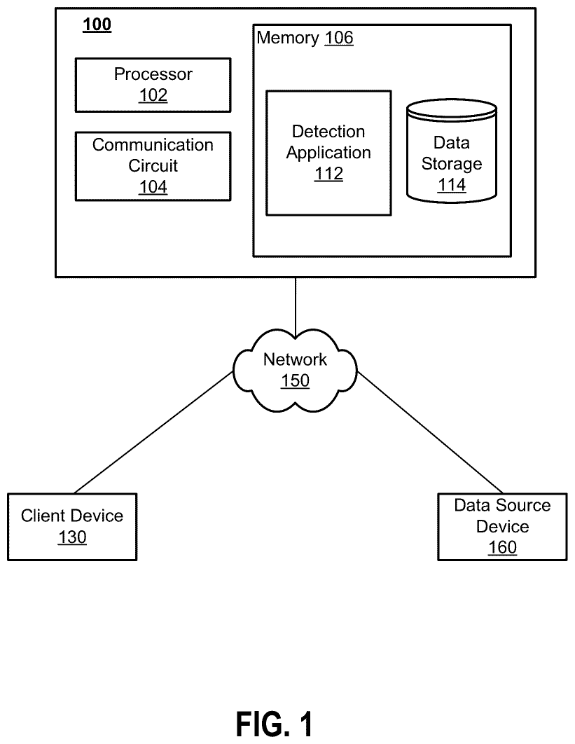

Reference is made to FIG. 1, which illustrates a system 100, in accordance with an embodiment of the present disclosure. The system 100 may transmit or receive data messages, via a network 150, to or from a client device 130 or one or more data source devices 160. While one client device 130 and one data source device 160 is illustrated in FIG. 1, it may be understood that any number of client devices or data source devices may transmit or receive data messages to or from the system 100.

The network 150 may include a wired or wireless wide area network (WAN), local area network (LAN), a combination thereof, or other networks for carrying telecommunication signals.

In some embodiments, network communications may be based on HTTP post requests or TCP connections. Other network communication operations or protocols may be contemplated.

The system 100 includes a processor 102 configured to implement processor-readable instructions that, when executed, configure the processor 102 to conduct operations described herein. For example, the system 100 may be configured to conduct operations for generating predictions on whether data operations for sets of data records adhere to organizational policies. Such example generated interim predictions may be generated in parallel with execution of the data operations on volumes of data records.

In another example, the system 100 may be configured to generate interim predictions on whether data records or data operations adhere to organizational policies based on a subset of data operations conducted up until a particular point in time, such that actively executed audit operations may be benchmarked against detection model outputs.

As an example, generated predictions may include categorical predictions representing whether data records or data operations may be satisfactory, require improvement, or unsatisfactory, among other examples of categorical predictions. In examples described in the present disclosure, three categorical predictions are described; however, any number of categorical predictions may be used.

In some embodiments, detection models may be based on trends, statistical measures, or other status quo metrics associated with data sets from prior points in time. In some embodiments, the detection models may be trained or configured for identifying institutional abnormalities, such as potentially un-scrutinized, erroneous, inaccurate, or fraudulent data records. Further examples will be described herein.

In some embodiments, the processor 102 may be a microprocessor or microcontroller, a digital signal processing processor, an integrated circuit, a field programmable gate array, a reconfigurable processor, or combinations thereof.

The system 100 includes a communication circuit 104 configured to transmit or receive data messages to or from other computing devices, to access or connect to network resources, or to perform other computing applications by connecting to a network (or multiple networks) capable of carrying data.

In some embodiments, the network 150 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks. In some examples, the communication circuit 104 may include one or more busses, interconnects, wires, circuits, or other types of communication circuits. The communication circuit 104 may provide an interface for communicating data between components of a single device or circuit.

The system 100 includes memory 106. The memory 106 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 106 may be storage media, such as hard disk drives, solid state drives, optical drives, or other types of memory.

The memory 106 may store a detection application 112 including processor-executable instructions that, when executed, configure the processor 102 to conduct operations described in the present disclosure. In some embodiments, the anomaly prediction application 112 may include operations for training one or more detection models based on received volumes of data records.

In some embodiments, the detection application 112 may include operations of monitoring for anomalous data records in a plurality of data records, and of identifying potentially outlier or anomalous data records, thereby indicating that sets of data records or data operations conducted on such data records may not adhere to data record accuracy or data record completeness policies, among other organizational policy criteria.

The system 100 includes a data storage 114. In some embodiments, the data storage 114 may be a secure data store. In some embodiments, the data storage 114 may store one or more data records received from the data source device 160. In some embodiments, the data storage 114 may include sets of data records subject to example data operations, such as audit operations.

As described, the system 100 may conduct operations to monitor one or more data records or data operations conducted on such data records and determine a prediction on whether such data records adhere to data record accuracy, data record completeness, or organizational policies.

The client device 130 may be a computing device, such as a mobile smartphone device, a tablet device, a personal computer device, or a thin-client device. The client device 130 may be configured to transmit messages to/from the system 100 for querying data records associated with one or more meta attributes. As will be disclosed in examples of the present disclosure, one or more meta attributes may be associated with characteristics of the particular data record individually or of the particular data record relative to other data records in a plurality of data records.

The client device 130 may include a processor, a memory, or a communication circuit, similar to the example processor, memory, or communication circuit of the system 100. In some embodiments, the client device 130 may be a computing device associated with a local area network. The client device 130 may be connected to the local area network and may transmit one or more data sets or signals to the system 100.

The data source device 160 may be a computing device, such as data servers, database devices, or other data storing systems associated with data records or data operations on such data records. As a non-limiting example, the data source device 160 may be associated with a banking institution. The data source device 160 may include one or more of a general ledger, journal entry systems, human resource data systems, finance data servers for foreign exchange rates, or the like. Journal entries may be data records for capturing resource transfers between accounts or parties. Other example data source devices may be used.

Referring again to the detection application 112 described with reference to FIG. 1, the detection application 112 may be based on or include a model for generating predictions on whether data operations for data records adhere to data record accuracy or data record completeness policies, among other organizational policies. In some embodiments, the detection application 112 may generate one of three possible predictions, including satisfactory, require improvement, or unsatisfactory.

In some embodiments, the detection application 112 may include a detection model based on a multinomial logistic regression. The detection model may be based on and an extension of a regular logistic regression model for adapting multi-label predictions. As a regression, such a model may be interpretable. In some scenarios, generated predictions may be interim predictions at a specific point in time during execution of data operations, among other operations. In some scenarios, generated predictions may be provided as a tool for substantial-real time benchmarking of data operations or may supplement predictions by auditor users.

To illustrate an example embodiment, the detection application 112 may be based on a plurality of predictor variables for generating a prediction. For example, predictor variables (or simply referred to as “predictors”) may include: (1) count of a first level of issues, (2) count of a second level of issues, (3) percentage of ineffectively designed controls, (4) percentage of controls that have an operating effectiveness of “not met”, (5) percentage of controls that have an operating effectiveness of “partially met”, (6) count of self-identified issues, or (7) whether or not a particular audit is considered regulatory subject matter.

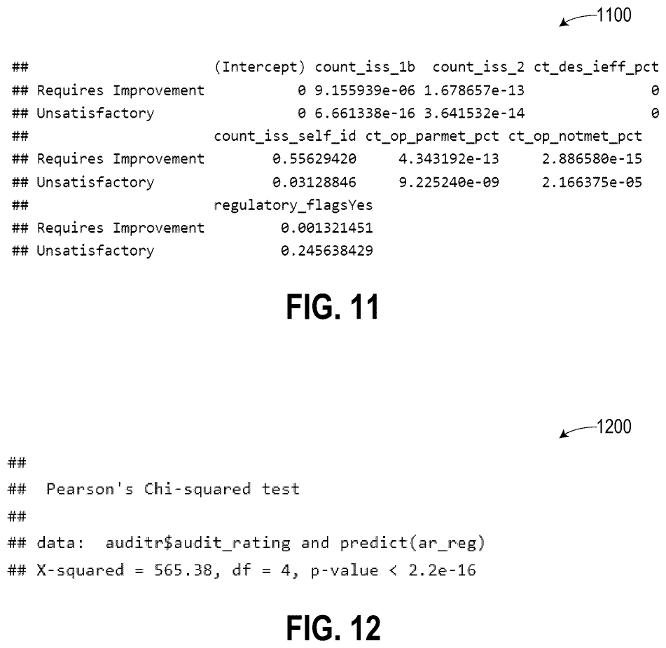

In some embodiments, when the detection application or detection model 112 is implemented based on a multinomial regression model, p-values may be a measure of statistical association between a predictor and the response, where a lower p-value may be associated with a stronger association, as shown in FIG. 11, which illustrates p-values associated with each predictor variable and an associated audit rating in an example 1100.

In some scenarios, there may be evidence (e.g., p=0.03) that the count of self identified issues has an effect on whether or not an audit is rated as unsatisfactory (UNSAT) beyond random occurrence alone, but this association may not extend to a prediction of require improvement (RI) ratings (e.g., p=0.56).

In some scenarios, there may be strong evidence (p=0.001) that regulatory audits may have an effect on whether or not an audit is rated as RI beyond random occurrence alone, but this association may not extend to UNSAT ratings (p=0.25).

In some scenarios, there may be very strong statistical evidence (p<0.0001) to suggest a relationship between all remaining predictors and the audit rating.

Based on the above example scenarios, a count of self-identified issues and regulatory audit indicators may be removed from the model, at least, because its statistical significance may not extend to every audit rating. Other predictor factors may be retained in embodiment models of the present disclosure.

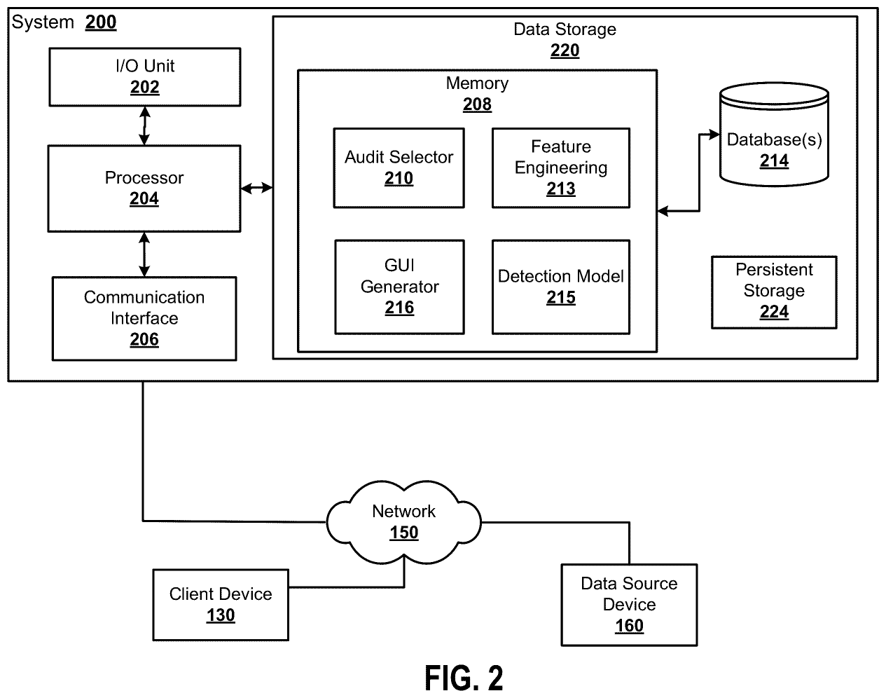

Referring now to FIG. 2, which Illustrates another block diagram of an example embodiment of a system 200 for dynamic data operation modeling, in accordance with an embodiment of the present disclosure. System 200 includes an I/O unit 202, a processor 204, a communication interface 206, and a data storage 220. I/O unit 202 enables system 200 to interconnect with one or more input devices, such as a keyboard, mouse, camera, a touch screen, and/or with one or more output devices such as a display screen and a speaker.

Processor 204 executes instructions stored in memory 208 to implement aspects of processes described herein. For example, processor 204 may execute instructions in memory 208 to configure an audit selector application 210, feature engineering application 213, machine learning application 215, and graphical user interface (GUI) generator application 216, and other functions described herein.

Processor 204 can be, for example, various types of general-purpose microprocessor or microcontroller, a digital signal processing (DSP) processor, an integrated circuit, a field programmable gate array (FPGA), a reconfigurable processor, or any combination thereof.

Communication interface 206 enables system 200 to communicate with other components, to exchange data with other components (e.g., client device 130 or data source device 160), to access and connect to network resources, to serve applications, and perform other computing applications by connecting to a network 150 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi or WiMAX), SS7 signaling network, fixed line, local area network, wide area network, and others, including any combination of these.

Data storage 220 can include memory 208, databases 214, and persistent storage 224. Data storage 220 may be configured to store information associated with or created by the components in memory 208 and may also include machine executable instructions. Persistent storage 124 implements one or more of various types of storage technologies, such as solid state drives, hard disk drives, flash memory, and may be stored in various formats, such as relational databases, non-relational databases, flat files, spreadsheets, extended markup files, etc.

Data storage 220 can store one or more models for machine learning application 215.

Memory 208 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

System 200 may connect to a client device 130 or web-based application (not shown) accessibly by the client device 130. The client device 130 or web-based application interacts with the system 200 to exchange data (including control commands) and generates visual elements for display at the client device 130 or web-based application. The visual elements can represent an audit type from audit selector application 210, features from feature engineering application 213, or one or more results from machine learning application 215.

System 200 may be operable to register and authenticate users (using a login, unique identifier, and password for example) prior to providing access to applications, a local network, network resources, or other networks.

Processor 204 is configured to execute machine executable instructions (which may be stored in memory 208) to maintain audit selector application 210, feature engineering application 213, and machine learning application 215. In some embodiments, processor 204 is configured to execute machine executable instructions to train one or more of audit selector application 210, feature engineering application 213 and machine learning application 215.

Data sets may include a plurality of data records. In some examples, data records may include records of resources, and resources may be associated with monetary funds, digital assets, tokens, precious materials, or other types of resources. Other types of data sets or data records having data structures for capturing other types of data may be contemplated. In some embodiments, data records may be associated with or include meta attributes. Meta attributes may be descriptive or representative of characteristics associated with respective data records, or descriptive or representative of a plurality of data records as a group.

In some scenarios, systems and methods may be configured to conduct data operations on a set of data records. Data operations may include operations to determine whether a set of data records adhere to data record accuracy or data record completeness policies of an organization, among other operations policies. Some examples described in the present disclosure may include data operations such as audit operations or functions. Other types of data operations for data records may be used.

In some embodiments, system 100, 200 may be configured to execute data operations on volumes of data records. In some embodiments, system 100, 200 may be configured to assess data operations executed on volumes of data records. System 100, 200 may be configured to execute or simulate data operations modelling for generating a signal representing prediction on whether the data operations for the data records are appropriate, based on an adherence level or score in view of a predefined metric or template. Such metric or template may be an audit template generated based on one or more rules or policies relating to data record accuracy or data record completeness, among other criteria.

For example, system 100, 200 may be configured to determine whether data operations on the data records may be satisfactory (SAT), require improvement (RI), or unsatisfactory (UNSAT) according to one or more standards or predefined metrics.

In practical application of some embodiments, system 100, 200 can be configured as a universal audit platform, which receives a user input representing an audit type and generates categorical predictions associated with dynamic operations (e.g., data operations) based on the audit type and data records available, and may further generate, though GUI generator application 216, graphical user interface elements to aid with users of client devices 130, such as auditors, in real time with an auditing process.

An audit type may refer to one of predefined auditing processes, such as, for example, a cybersecurity audit, an information technology (IT) system audit, a financial audit, an compliance audit, or an operational audit.

For instance, a cybersecurity audit may include an assessment of one or more networks, one or more physical devices on the network, and existing cybersecurity processes. Examples may include firewalls, user login processes, intrusion detection services, security controls, and privacy measures in place to prevent unauthorized parties from accessing private data. A cybersecurity audit is performed to assess if an organization's network and devices are sufficiently secure from fraud, phishing attacks, and hackers.

For another example, an IT audit may include an assessment of one or more computing devices, hardware, software and processes relating to software development, data processing, and other components relating to ensure that an organization's network and devices are compliant with a predefined set of IT rules or qualifications, to ensure data protection and data integrity.

Each audit process may involve a review and assessment of different data records relevant to the purpose of each respective audit. For instance, an auditor may choose to perform an operation (e.g. examining) on a set of data records (e.g., user login file) for a given assessment category. Traditionally, an auditor may review a significant amount of data records and perform a number of different operations on some or all of the data records, based on the auditing process. When there are two or more auditing processes for the same organization, the auditor would then conduct each auditing process independently from one another, and in the process, may perform the same or different data operations on a subset of data records for the same organization.

System 100, 200 is implemented, in some embodiments, to automate the auditing process such that similar data operations on similar data records may only need to be assessed once, when two or more auditing processes are selected.

For instance, both cybersecurity audit and IT audit may require an auditor (e.g., a user of client device 130) to review and assess various aspects like network security, access control, and user login files. System 100, 200 may be configured to, based on a selected audit type in an user input, automatically receives or constructs, through audit selector 210, an audit template for defining a set of data operations for one or more set of data records.

Each audit template may include one or more audit types, specifies core data records and dynamic data records, where type of each data record may be associated with one or more data operation, where an auditor or user may perform a data operation on a specific core or dynamic data record.

Core data records may be defined as data records that need to be operated on for two or more audit types. Dynamic data record may be defined as non-core data records that may be specific to each respective audit type. An audit type may be used to represent an auditing process.

Based on an audit type selected (e.g., “IT audit”), core data records may be processed using feature engineering 213 to generate a set of features defined in the audit template. One example of core data records may include a user log file detailing user account access attempts, including for example, user ID, user access control, IP address, device ID, timestamp, and so on. This user log file may be processed to generate a set of core features for the IT audit or a different type of audit (e.g., cybersecurity audit). Different types of audits may require similar core data records, and processing such core data records only once saves computing resources and improves efficiency in the overall auditing process, as opposed to generating new data operations or features thereof, each time an audit process is requested.

Core features (or primary features) may be generated using feature engineering application 213 based on the audit template selected or generated by the audit selector application 210.

Feature engineering application 213 may be configured to select salient or relevant features related to each audit type associated with the audit template. Without using the feature engineering application 213, a routine detection or machine learning model can spend computing resource on going through training or inference based on irrelevant features, such as noise or other data in the user log file. Feature engineering application 213 may generate feature vectors or other types of feature input data for detection model 215.

In addition, system 100, 200 as disclosed herein, can converge faster than systems without feature engineering model 213, as dimension of the feature vectors computed from the feature engineering model 213 can be lower, and the inference speed of detection model 112, 215 can therefore be much faster than traditional machine learning models without feature engineering model 213.

Dynamic data records may include a number of data records that may be processed by feature engineering model 213 to generate embeddings and other types of dynamic features. The dynamic data records may include, for example, free form text in an audit report or document where different controls are described with respect to risk and mitigation.

The dynamic data records tend to vary based on the audit type selected, and may be processed in an efficient manner using a large language model (LLM) to generate an input feature data set optimally suited for categorical predictions to be generated by detection model 215. An example free form text may include a document including one or more audit fields, an action plan, one or more scope fields, one or more controls, and each control may be described with respect to risk and mitigation, and consequences of if such a control is met. Feature engineering model 213 may be executed for generation of embeddings via large language models.

The generated features from the LLM in the feature engineering model 213 can be used to infer a class prediction with a downstream machine learning model, such as detection model 112, 215, which can include linear regression model that can generate the predictions using less computing resources as compared to complicated neural network models.

Examples of LLM may include GPT-3, GPT-3.5, GPT-4, BERT, Llama (large language model meta Al), and so on. For example, a LLM based on the transformer architecture may be implemented as part of the feature engineering model 213 to generate features for detection model 215.

In addition, system 100, 200 can be configured for displaying and explaining features and their respective values in contributing to the final prediction result, on a display screen of client device 130, as the features are readily available from feature engineering model 213.

Each data record, core or dynamic, may include metadata attribute indicating a specific data operation applicable thereto (e.g., an action that may be performed by an auditor).

In some embodiments, feature engineering application 213 can include a neural network to perform actions based on input data, which may include a set of data records and data operations represented by meta attributes associated with the data records.

An example neural network can include an input layer, a hidden layer, and an output layer. The neural network can process input data using its layers based on machine learning, for example. Once the neural network has been trained, it generates output data reflective of its decisions to take particular actions (e.g., feature generation) in response to particular input data. Input data may include one or more data records and associated meta attributes, while output data may include feature vectors that can be used as input data for a detection model or application 215 for determining a prediction for a data operation performed (or to be performed) on one or more data records at a respective time stage.

Once the core features and dynamic features are both extracted, a detection model (e.g., regression model) 215 is executed to generate categorical prediction for one or more data operations in the metadata attributes, which can be done in real time, to aid the auditor with efficient auditing.

System 100, 200 allows a user to select one or more different types of auditing process, and perform data operational modeling for one or more auditing processes. When multiple auditing types are selected, a pre-processing stage may occur, and one or more sets of data records are processed using feature engineering model 213 depending on the type of audit requested.

In some embodiments, for example, when both cybersecurity audit and IT audit are selected by a user, the core data records for both types of auditing processes may include core data records representing a user login file or log detailing an access timestamp, data stamp, IP address, device ID, and soon, for each login attempt for an user account.

At the same time, or as a subsequent step, different dynamic data records may be processed for each audit type using the LLM component in feature engineering model 213 for processing free form text to generate features or embeddings for the specific audit type.

In some embodiments, detection model 215 may be based on or include a model for generating predictions on whether data operations for data records adhere to data record accuracy or data record completeness policies, among other organizational policies. In some embodiments, detection model 215 may generate one of three possible predictions, including satisfactory, require improvement, or unsatisfactory.

In some embodiments, detection model 215 may include a multinomial logistic regression. Detection model 215 may be based on and an extension of a regular logistic regression model for adapting multi-label predictions. As a regression, such a model may be interpretable. In some scenarios, generated predictions may be interim predictions at a specific point in time during execution of data operations, among other operations. In some scenarios, generated predictions may be provided as a tool for substantial-real time benchmarking of data operations or may supplement predictions by auditor users.

As an example, the one or more signals representing the categorical prediction may represent whether the current data operations are satisfactory for identifying data records that have been approved or promoted at a specific rate (e.g., a user approving journal entries at a rate of 5 entries per minute). The categorical prediction may be a prediction on whether the current set of data operations are sufficient (or require improvement, or are unsatisfactory) for the intended purpose. By providing a user with dynamic user interface updates on a prediction on whether data operations are satisfactory for identifying adherence to organizational policies, the user may determine whether continuing with such data operations is worthwhile, thereby reducing wasted resources.

To illustrate an example embodiment, detection model 215 may be based on a plurality of predictors for generating a prediction. For example, predictors may include: (1) count of a first level of issues, (2) count of a second level of issues, (3) percentage of ineffectively designed controls, (4) percentage of controls that have an operating effectiveness of “not met”, (5) percentage of controls that have an operating effectiveness of “partially met”, (6) count of self-identified issues, or (7) whether or not a particular audit is considered regulatory subject matter.

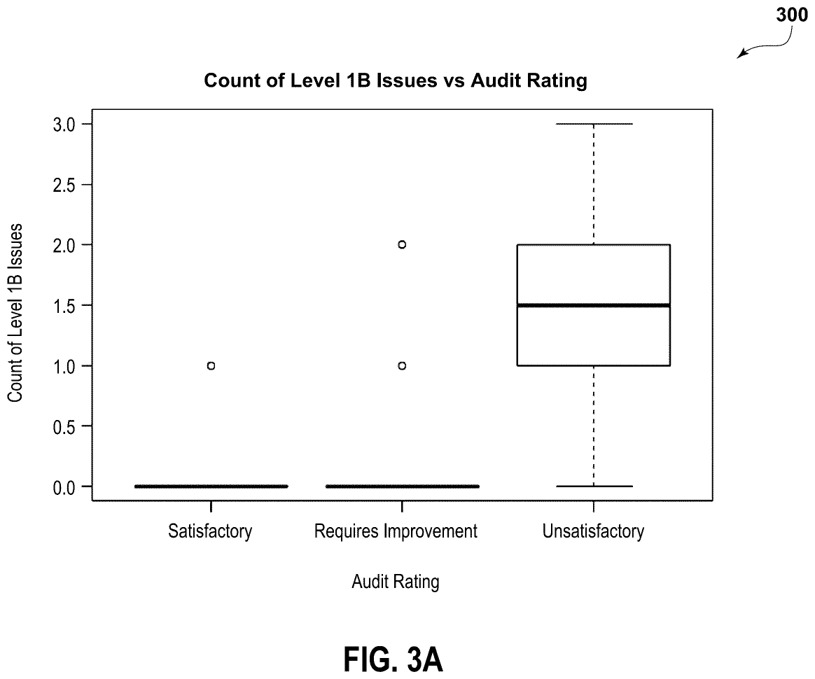

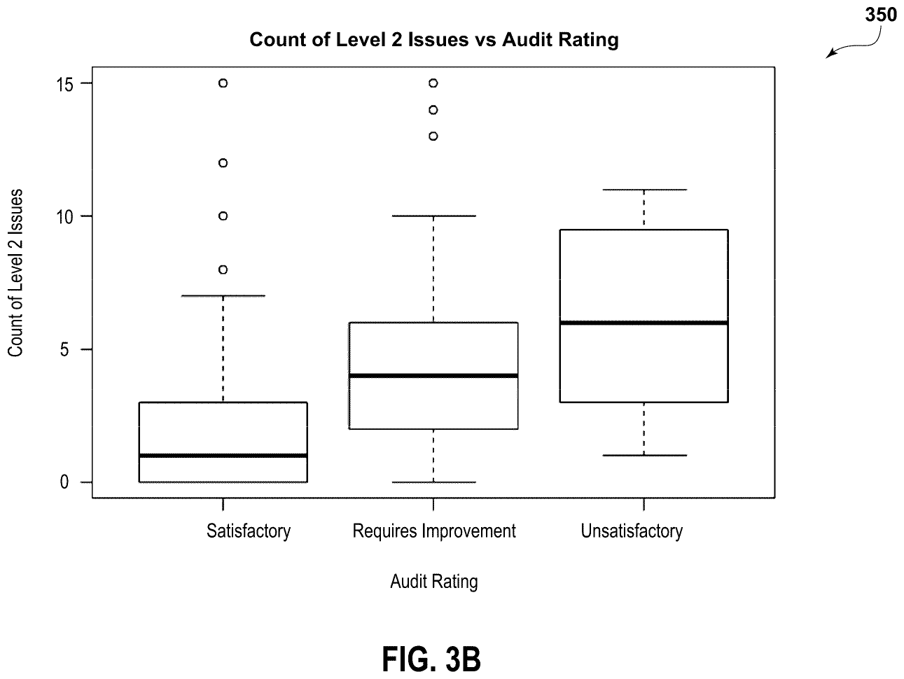

FIG. 3A shows an association plot 300 illustrating a count of a first level of issues (e.g., ‘level 1B’ issues) and ratings, in accordance with an embodiment of the present disclosure.

FIG. 3B shows an association plot 350 illustrating a count of a second level of issues (e.g., ‘level 2’ issues) and ratings, in accordance with an embodiment of the present disclosure.

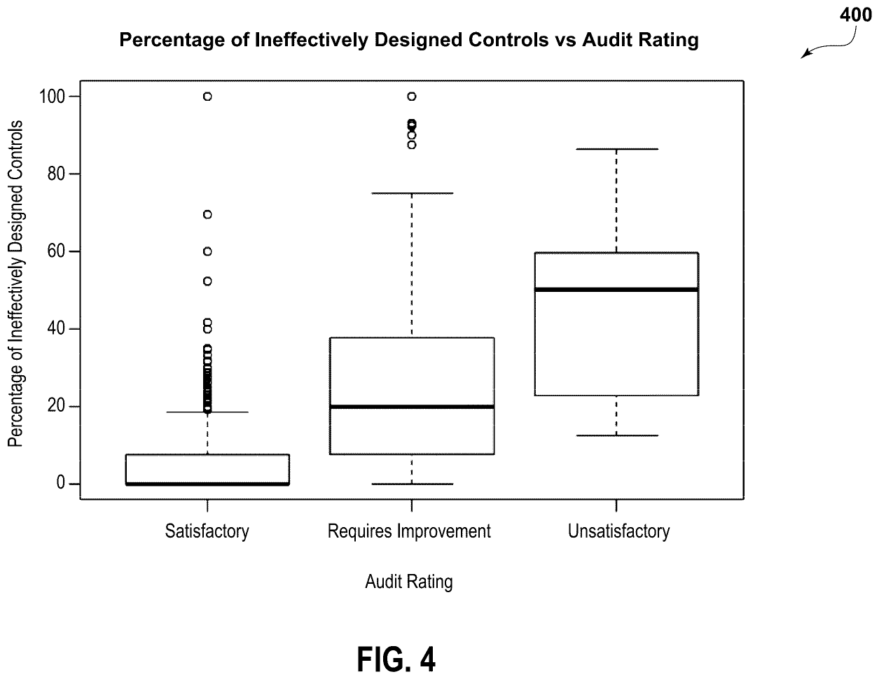

FIG. 4 shows an association plot 400 illustrating a percentage of ineffectively designed controls and ratings, in accordance with an embodiment of the present disclosure.

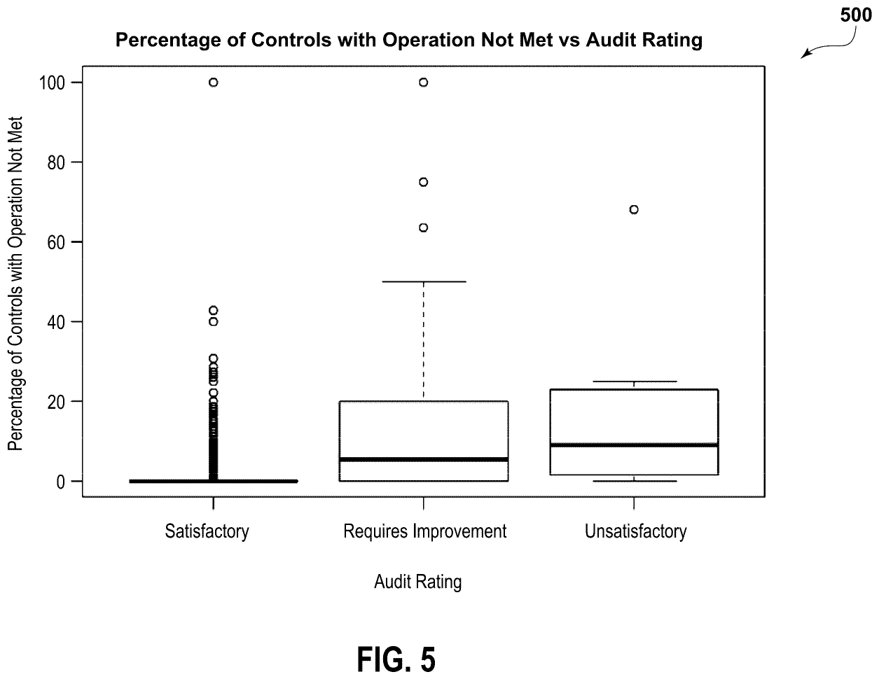

FIG. 5 shows an association plot 500 illustrating a percentage of controls with operation not met and ratings, in accordance with an embodiment of the present disclosure.

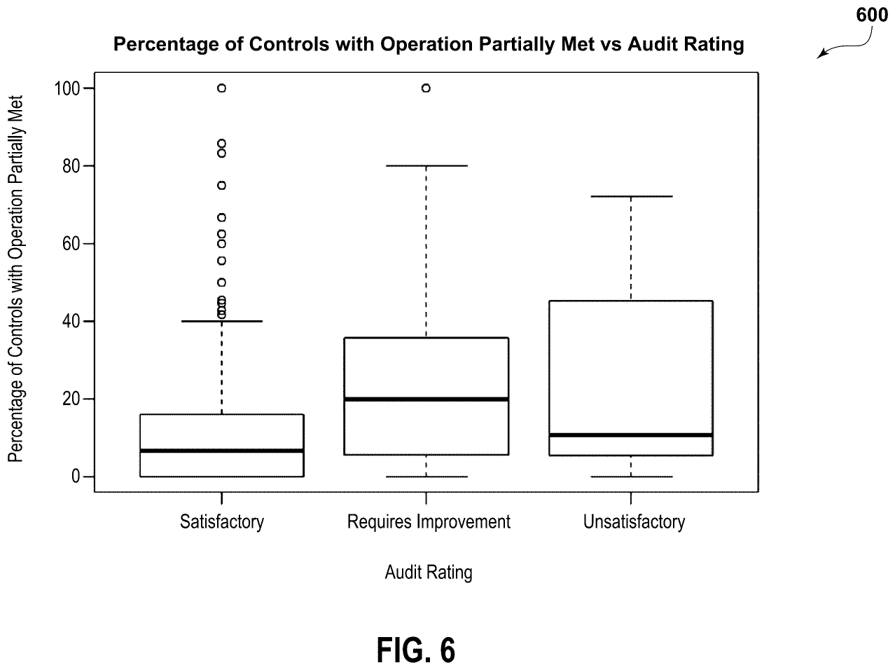

FIG. 6 shows an association plot 600 illustrating a percentage of controls with operation partially met and ratings, in accordance with an embodiment of the present disclosure.

In some embodiments, there may be a class imbalance (e.g., audit rating imbalance) in a set of generated predictions. For example, in a set of generated predictions, there may be 702 satisfactory ratings, 184 require improvement ratings, and 8 unsatisfactory ratings. As such, class weights may be associated with ratings to reduce the model from favouring most frequent classes in terms of prediction strength. In the present example, class weights may be assigned weight values as follows: SAT=1, RI=6, and UNSAT=30.

In the present example, satisfactory rating may be identified as a reference response category, as it is the most frequently occurring rating. In some embodiments, class weights may be determined based on relative frequency in which they may be observed in the data, and then tweaked based on training performance through cross validation.

In some embodiments, detection model 112, 215 may be trained periodically based on finalized audit reports, and the set of updated model coefficients can be updated accordingly, such as in a SQL table. An audit template may be updated accordingly, which can configured as a default audit template having the most recent set of coefficients by querying the aforementioned table. Users can see how the model's prediction changes as they add data to said audit template.

In some embodiments, multi-collinearity may be determined. For example, as illustrated in the chart below, there may be a state where predictors described above may be correlated with another predictor, and this is not appropriate for a regression. The variance inflation factor (VIF) may be calculated and associated with respective predictors by performing a standard linear regression after converting an audit rating to an ordinal, such as 1=SAT, 2=RI, and 3=UNSAT. Variance inflation factors may be low for all predictors. For example, multi-collinearity may not have an appreciable effect.

| ## | count_iss_1b | count_iss_2 | ct_des_{—} | ct_op_{—} |
|---|---|---|---|---|
| | | | ieff_pct | parmet_pct |
| ## | 1.093013 | 1.373848 | 1.463201 | 1.222258 |
| ## | ct_op_{—} | | | |
| | notmet_pct | | | |
| ## | 1.373412 | | | |

Explained in an alternate manner, Pearson's Chi-squared test may be an example method for assessing fit for a regression. In example 1200 in FIG. 12, the lower the p-value, the greater the fit. Given p<0.0001, there may be very strong evidence that the regression model appropriately fits data.

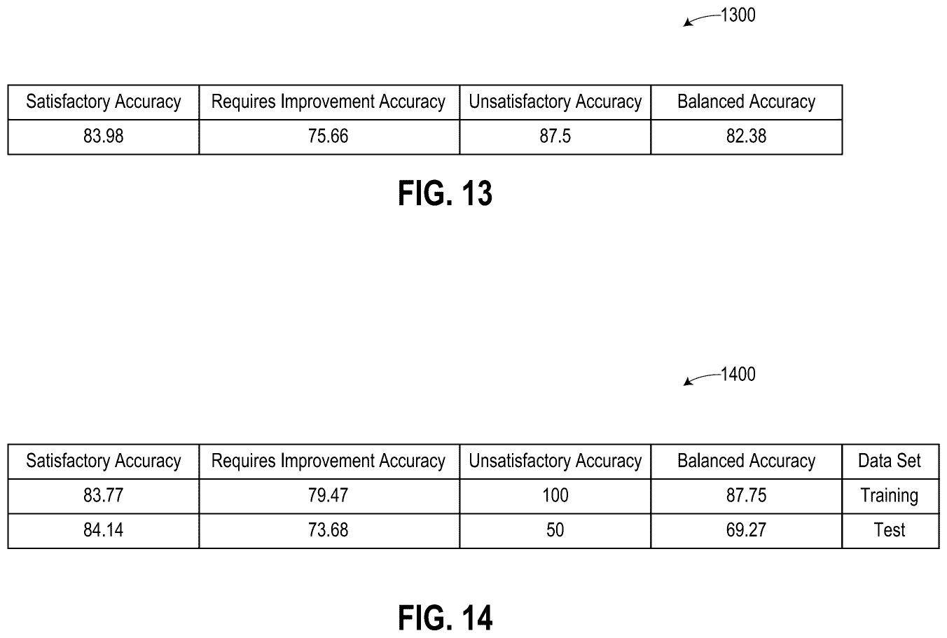

In an example as illustrated in table 1300 in FIG. 13, class specific accuracies are shown alongside the balanced accuracy. Balanced accuracy values may be appropriate measures of overall performance, as it is the average of class specific accuracies. In some scenarios, a balanced accuracy of 82.38% indicates reasonable performance.

In some embodiments, data sets may be divided or portioned into training and test sets to determine if the model generalizes to information that it was not specifically trained on. Example results shown in table 1400 in FIG. 14 illustrate that performance generalizes and overfitting may not be present. The low performance for unsatisfactory audit ratings in the test set may be expected given a low volume of training data.

In some embodiments described herein, the prediction application 112 may include a prediction model based on a multinomial logistic regression, where the regression coefficients may be interpreted in terms of an odds ratio. Respective coefficients may be a continuous measure. Example interpretations are described below for respective predictors alongside the regression's coefficients:
1. A one unit increase in the count of level 1 B issues may be associated with a 412.43 factor increase in the odds of an audit being rated unsatisfactory as opposed to satisfactory.
2. A one unit increase in the count of level 2 issues may be associated with a 1.50 factor increase in the odds of an audit being rated unsatisfactory as opposed to satisfactory.
3. A one percent increase in the percentage of ineffectively designed controls may be associated with a 1.13 factor increase in the odds of an audit being rated unsatisfactory as opposed to satisfactory.
4. A one percent increase in the percentage of controls with an operating effectiveness of “partially met” may be associated with a 1.04 factor increase in the odds of an audit being rated unsatisfactory as opposed to satisfactory.
5. A one percent increase in the percentage of controls with an operating effectiveness of “not met” may be associated with a 1.06 factor increase in the odds of an audit being rated unsatisfactory as opposed to satisfactory.

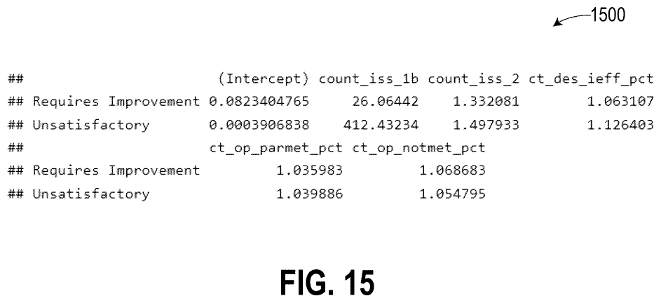

In some embodiments, a size of a coefficient may determine or be correlated with a strength of a relationship between a given predictor and an audit rating. In some scenarios, in terms of results, they may be intuitive as the volume of 1 B issues (as an example) may be a strong predictor for whether or not an audit may be rated as RI or UNSAT. In some scenarios, as illustrated in example 1500 in FIG. 15, five predictors may indicate a higher likelihood of obtaining a worse audit rating as they rise in value, and the example coefficients may confirm this hypothesis.

In some embodiments, the prediction application based on the detection model 112 may be based on one or more limiting factors. For example, a volume of overall data may be relatively small. Upon removing non-core audits from data sets, there may be fewer number of observations to train the detection model. While such a data set may be sufficient to generate a reasonably performing model, performance limitations may exist.

In some scenarios, there may be appreciable class imbalance in the data sets. In an above-describe example, there may be 702 SAT predictions, 184 RI predictions, and 8 UNSAT predictions in a sample data set. In some embodiments, there may be errors associated with predictions, despite a balanced accuracy at ˜78.9%, which may be considered reasonable.

In some scenarios, performance measurements may presume that the labels present in training data sets may be “true” and correct labels. If, for example, an audit was predicted and rated as SAT when it should have been rated RI, and the model predicts RI, this may be labeled as an incorrect prediction. The above described example refers to correctness of ground truth. For instance, the above described example provides whether or not a user determining of audit ratings was conducted as expected. In many scenarios, audit ratings are determined as expected. Otherwise training a prediction model would not be possible, and performance metrics would not be determinable.

In some scenarios, prediction model implementations for dynamic and substantially real-time predictions may require embodiments of detection models to be embedded and integrated with a specific graphical user interface template. Other implementations may provide for prediction models in a modular way.

In some scenarios, systems may be configured with hard-coded, rules-based operations for predicting whether data operations on the set of data records adhere to example data record accuracy or data record completeness criteria. Such hard-coded, rule-based operations may be defined by decision tree models. Example decision tree models may be developed based on years of expert experience and based on manual canvas by an auditor user of voluminous sets of data records.

Overtime, the above-described hard-coded, rules-based decision tree models may not be representative of evolving organizational policies relating to data record accuracy or data record completeness criteria. In some scenarios, updates to or alterations to hard-coded, rules-based decision tree models may require manual processes by expert users based on time-intensive, laborious canvas of voluminous sets of data record. Further, in some scenarios, hard-coded, rules-based decision tree models may not be representative of underlying data at the time of model training. Such rules-based models may not necessarily correspond with trends in observable data sets over time.

It may be desirable to provide systems and methods for dynamic data operations modeling for generating predictions on whether data operations conducted on sets of data records adhere to organizational policies, such as policies relating to data record accuracy or data record completeness, among other example criteria.

In some scenarios, it may be desirable to provide systems and methods for generating interim predictions on data operations adherence to organizational policies in parallel with execution of data operations on volumes of data records. By generating interim predictions in substantially real-time and in parallel with execution of data operations, a client device may display benchmarking data for assessing actual data operations on data records against expect (predicted) data operations based on detection models trained based on data records of prior time.

In some embodiments and features described herein, systems may include detection models based on multinomial logistic regression models or an ordinal regression model. In some embodiments, detection models may include other types of models such as explainable gradient boasting machine models.

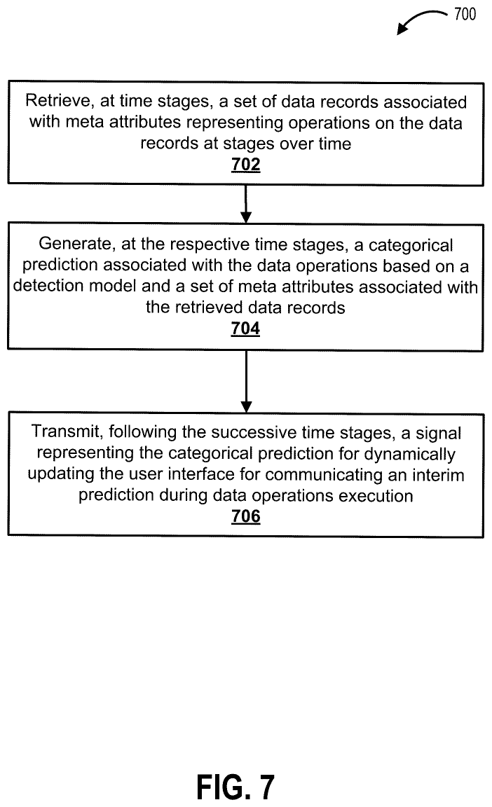

Reference is made to FIG. 7, which illustrates a method 700 for dynamic data operations modelling, in accordance with an embodiment of the present disclosure. The method 700 may be conducted by the processor of system 100, 200. Processor-executable instructions may be stored in the memory 206 and may be associated with the detection application 112 or other processor-executable applications not explicitly illustrated in FIG. 1 or FIG. 2. The method 700 may include operations such as data retrievals, data manipulations, data storage, or other operations, and may include computer-executable operations.

For ease of exposition, the method 700 may be described with reference to an example banking institution system configured to generate categorical predictions associated with data operations for volumes or sets of data records. Data records being monitored may include example manual journal entries, where manual journal entries may be for tracking resource transfers. In some other embodiments, manual journal entries may be for other types of records.

In some embodiments, respective manual journal entries may be associated with meta attributes, which may be representative of characteristics of data records individually or relative to other data records in a dataset. As an example, a meta attribute may represent a rate at which a series of journal entries (including the given journal entry) may have been approved by an approver user. In another example, a meta attribute may represent whether the journal entry includes descriptive text having flag words that may suggest a potential anomalous data record. In another example, a meta attribute may represent whether the given journal entry has been revised or corrected since journal entry creation.

In some scenarios, manual journal entries may need to be approved or otherwise scrutinized by an approver user (associated with a client device) prior to being promoted or advanced to a subsequent resource transfer process. In scenarios where the approver user may not appropriately scrutinize a journal entry, it may be beneficial to provide methods of monitoring for anomalous data records, thereby increasing a chance or confidence that approval of manual journal entries adhere to policies associated with accuracy, completeness, or other factors.

In some embodiments, systems may be configured with detection models including multinomial logistic regression models for generating predictions on whether subject data operations are satisfactory. The example detection models may be trained based on audit user control test outcomes, prior-identified issues, or prior-identified issue levels, among other example training data set data, for generating interim predictions on data operations adherence to organizational policies. In some embodiments, the detection models may be based on prior-identified trends, statistical measures, or other status quo metrics associated with data records from prior points in time.

In some embodiments, the detection models may be continually trained and update for identifying organizational abnormalities recorded among data records, such as potentially un-scrutinized, erroneous, inaccurate, or fraudulent data records, among other examples. Examples of various embodiments will be described in the present disclosure.

At operation 702, the processor may retrieve, at time stages, a set of data records associated with meta attributes representing operations on the data records at stages over time.

In some embodiments, data operations may be audit operations or functions. The data records may respectively be associated with meta attributes. The meta attributes may represent characteristic of the particular data record individually or of the particular data record relative to other data records in a plurality of data records. In some embodiments, the meta attributes may represent data operation results or issue severity level for audit data operations. For example, data operation results may include identifiers such as “effective”, “ineffective”, “met”, “partially met”, or “not met”, among other example identifiers. That is, meta attributes may represent a recordation on results of data operations for the data records.

In some embodiments, the processor may generate the meta attributes on a substantially real-time basis for associating with data records during the course of data operations execution.

At operation 704, the processor may generate, at the respective time stages, a categorical prediction associated with the data operations based on a detection model and a set of meta attributes associated with the retrieved data records. For example, the categorical prediction may provide an indication on whether the data operations for data records is suitable for determining adherence to data record accuracy or data record completeness organizational policies, among other examples of organizational policies.

Continuing with examples described above, the categorical prediction may be one of “satisfactory”, “require improvement”, or “unsatisfactory” for indicating whether data operations for canvasing journal entry text (e.g., within a data record) are sufficient for identifying inappropriate data records.

In another example, the categorical prediction may be one of “satisfactory”, “require improvement”, or “unsatisfactory” for indicating whether data operations for identifying whether one or more criteria for determining whether a series of journal entries may have been approved at a rate representative of sufficient journal entry review.

In some embodiments, the detection model may be based on a multinomial logistic regression model providing the categorical prediction for adapting multi-label predictions.

In some embodiments, the detection model may be based on an ordinal regression model.

In some embodiments, the categorical prediction may be an interim categorical prediction generated prior to a set of data operation executions are completed. In some scenarios, a set of data operation executions may be conducted over a period of time, providing the interim categorical prediction may provide a user with interim indications on the trajectory or usefulness of the data operations for the data records.

In some embodiments, the detection model may be based on a set of model features considered for the categorical prediction. For example, the set of model features may include counts of a spectrum of identified issue levels, a percentage of ineffectively designed controls, a percentage of controls that have an operating effectiveness of “not met”, a percentage of controls that have an operating effectiveness of “partially met”, a count of self-identified issues, or whether or not an audit is regulatory.

In some embodiments, the processor may train the detection model by determining one or more regression coefficients based on an odds ratio among the respective model features. In some embodiments, the processor may determine statistical association among respective multi-label predictions for excluding at least one model feature from training the detection model. In some examples of model training, operations for minimizing a loss function is based on gradient descent operations. Example model coefficients may converge to values once minimization operations are conducted. In some examples, Broyden-Fletcher-Goldfarb-Shanno (BFGS) operations may be conducted. The model's coefficients may be generated based on the log odds ratio or through a standard odds ratio if the coefficients are exponentiated.

In some embodiments, the processor may determine variance inflation factors for generating class weights to associate with respective multi-label predictions. Such generated class weights may be desirable to address class imbalances among multi-label prediction values.

In some embodiments, operations may include or be based on variance inflation factors v (VIFs) to assess multi-collinearity, rather than generate class weights. Multi-collinearity may be conducted when predictors are present that are highly correlated with one another. If a model is trained with high multi-collinearity present, it will likely not be reliable. Class weights may be determined through performance assessments by way of cross validation operations. The cross validation operations may include a grid search algorithm that analyzes many different sets of class weights based on relative frequencies as an initialization point, thereby determining coefficients that may maximize the balanced accuracy.

In some embodiments, the multi-label predictions may include “satisfactory”, “require improvement”, or “unsatisfactory”. Other prediction labels may be used.

In some embodiments, the successive time stages may be at periodic or non-periodic time intervals. In examples where the successive time stages are at non-periodic time intervals, the processor may generate the categorical predictions on a cadence that corresponds to the receipt of sets of data records, which may be at non-periodic time stages.

At operation 706, the processor may transmit, following the respective time stages, one or more signals representing the categorical prediction for dynamically updating the user interface for communicating an interim prediction during data operations execution. For example, the user interface may display a suggested overall predicted data operations rating. In some embodiments, the user interface may include user interface elements for providing explanations for the data operations prediction.

As an example, the one or more signals representing the categorical prediction may represent whether the current data operations are satisfactory for identifying data records that have been approved or promoted at a specific rate (e.g., a user approving journal entries at a rate of 5 entries per minute). The categorical prediction may be a prediction on whether the current set of data operations are sufficient (or require improvement, or are unsatisfactory) for the intended purpose. By providing a user with dynamic user interface updates on a prediction on whether data operations are satisfactory for identifying adherence to organizational policies, the user may determine whether continuing with such data operations is worthwhile, thereby reducing wasted resources.

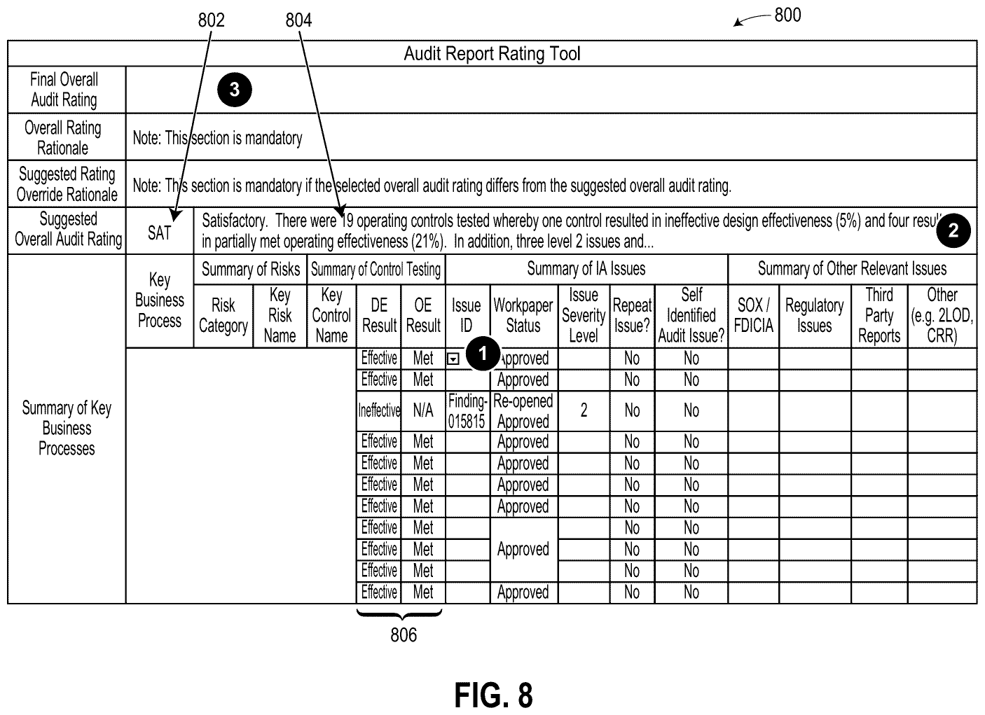

FIG. 8 illustrates a user interface 800 for displaying categorical predictions during data operations execution, in accordance with an embodiment of the present disclosure.

The user interface 800 may include a plurality of data operations categories illustrated as rows in the user interface 800. Respective data operations categories may include user interface elements 806 for receiving user input. In some embodiments, user input may include signals representing data operations, such as “effective”, “in effective”, “met”, “partially met”, or “not met”, among other example indications.

In some embodiments, a user may interact with the user interface 800 and provide input on the respective data operations categories over time.

The user interface 800 may include an interim prediction or overall suggested prediction at a suggestion interface 802. The prediction may be a categorical prediction generated at operation 704 described with reference to FIG. 7. The categorical prediction may be an interim prediction based on a subset of provided signals at the interface elements 806 during data operations execution.

In some embodiments, prior to a user providing user input on data operations categories, the processor may generate the interim prediction based on the subset of user input provided at the current point in time.

In some embodiments, upon the receiving a complete set of user input on data operations categories (e.g., audit operations completed), the processor may generate the prediction and display the suggestion interface 802 for illustrating the categorical prediction for the set of data operations for data records.

In some embodiments, the user interface 800 may include an explanatory interface 804 to provide granular details on contributing factors leading to the categorical prediction generated at the suggestion interface 802. For example, the explanatory interface 804 may include text output noting a percentage of types of criteria/features leading to the categorical prediction. Non-textual output for providing granular details leading to the categorical prediction may be contemplated.

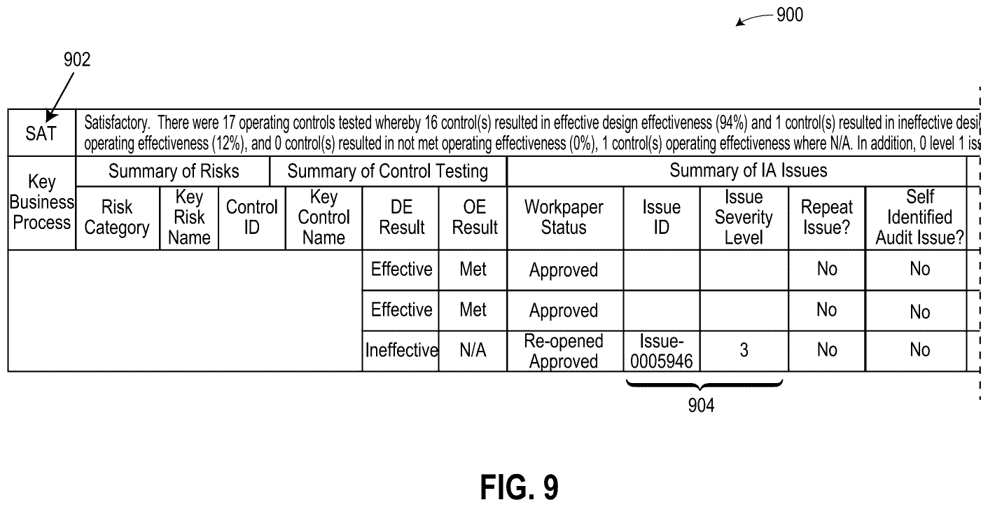

FIG. 9 illustrates a partial, enlarged user interface 900 for displaying categorical predictions during data operations execution, in accordance with an embodiment of the present disclosure.

In FIG. 9, a categorical prediction is provided at the suggestion interface 902 based on currently available user inputs 904 associated with the data operations categories completed at the current time. In the example illustrated in FIG. 9, one of three data operations categories have been completed with user input.

As described, in some embodiments, it may be desirable to generate and display interim categorical predictions based on user input for data operations categories over time.

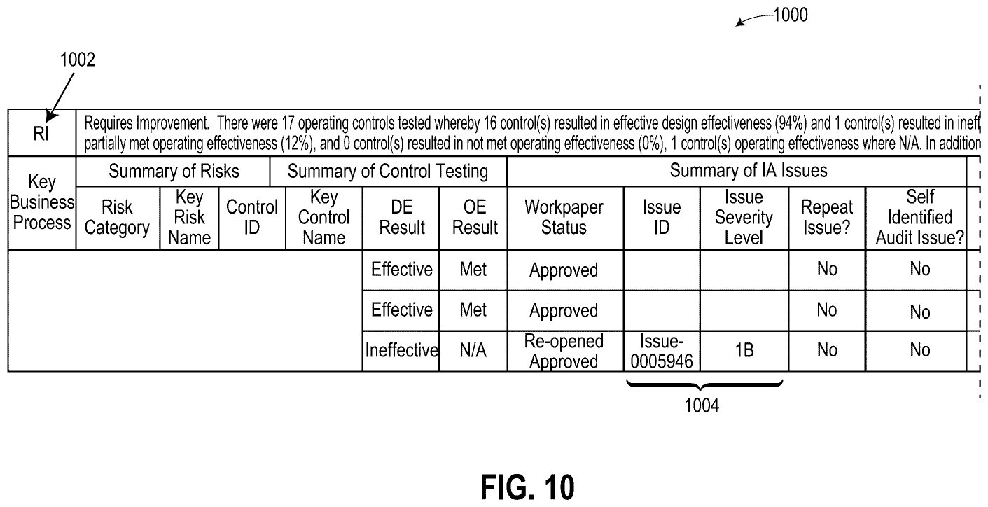

FIG. 10 illustrates the partial, enlarged user interface 900 of FIG. 9 at a subsequent point in time. In FIG. 10, a user input for “issue severity level” has been altered for a particular data operations category. The processor may generate, in substantial real time, an update to the output at the suggestion interface 1002 based on the dynamically altered user input.

In the illustrated example of FIG. 10, the suggestion interface 1002 has been updated from “satisfactory” (SAT) to “require improvement” (RI) based on user inputs 1004 at the user interface 1000. By generating interim predictions in substantially real-time and in parallel with execution of data operations, a client device may display benchmarking data for assessing actual data operations on data records against expect (predicted) data operations based on detection models trained based on data records of prior time.

Some of the figures described herein describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation.

In other embodiments, any single component illustrated in the figures may be implemented by a number of actual components. The depiction of any two or more separate components in the figures may reflect different functions performed by a single actual component. The figures discussed below provide details regarding example systems that may be used to implement the disclosed functions.

Some concepts are described in form of steps of a process or method. In this form, certain operations are described as being performed in a certain order. Such implementations are example and non-limiting. Certain operations described herein can be grouped together and performed in a single operation, certain operations can be broken apart into plural component operations, and certain operations can be performed in an order that differs from that which is described herein, including a parallel manner of performing the operations. The operations can be implemented by software, hardware, firmware, manual processing, and the like, or any combination of these implementations. As used herein, hardware may include computer systems, discrete logic components, such as application specific integrated circuits (ASICs) and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “connected” or “coupled to” may include both direct coupling (in which two elements that are coupled to each other contact each other) and indirect coupling (in which at least one additional element is located between the two elements).

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

1. A system for dynamic data operations modeling comprising:
a processor; and
a memory coupled to the processor and storing processor-executable instructions that, when executed, configure the processor to:
receive a set of data records associated with meta attributes representing operations on the data records, the operations performed over a sequence of time stages;
generate, by a detection model at each respective time stage from the sequence of time stages, a categorical prediction associated with the data operations using the meta attributes, the detection model based on a multinomial logistic regression providing the categorical prediction for adapting multi-label predictions; and
transmit, following the sequence of time stages, one or more signals representing one or more from the categorical predictions for dynamically updating the user interface for communicating an interim categorical prediction during data operations execution.

2. The system of claim 1, wherein the detection model is based on a set of model features considered for the categorical prediction, wherein the processor is configured to:
train the detection model by determining one or more regression coefficients based on odds ratio among for respective model features.

3. The system of claim 2, wherein the processor is configured to determine statistical association among respective multi-label predictions for excluding at least one model feature from training the detection model.

4. The system of claim 1, wherein the sequence of time stages are at non-periodic time intervals.

5. The system of claim 1, wherein the processor is configured to: determine variance inflation factors for generating class weights to associate with respective multi-label predictions.

6. The system of claim 1, wherein the detection model is based on an ordinal regression for determining variance inflation factors.

7. The system of claim 1, wherein the multi-label predictions includes a satisfactory, a require improvement, or an unsatisfactory prediction.

8. The system of claim 1, wherein the processor is configured to:
receive user input representing an audit type;
generate a first set of features based on the set of data records using feature engineering;
transmit the first set of features to the detection model; and
generate, by the detection model at each respective time stage from the sequence of time stages based on the first set of features, the categorical prediction associated with the data operations using the meta attributes.

9. The system of claim 8, wherein the processor is configured to:
receive a second user input representing a second audit type;
generate a second set of features based on the set of data records using feature engineering;
transmit the second of features to the detection model; and
generate, by the detection model at each respective time stage from the sequence of time stages based on the second set of features, the categorical prediction associated with the data operations using the meta attributes.

10. The system of claim 9, wherein at least one of the first and second set of features are generated using large language model.

11. A computer-implemented method for dynamic data operations modelling comprising:
receiving a set of data records associated with meta attributes representing operations on the data records, the operations performed over a sequence of time stages;
generating, by a detection model at each respective time stage from the sequence of time stages, a categorical prediction associated with the data operations using the meta attributes, the detection model based on a multinomial logistic regression providing the categorical prediction for adapting multi-label predictions; and
transmitting, following the sequence of time stages, one or more signals representing one or more from the categorical predictions for dynamically updating the user interface for communicating an interim categorical prediction during data operations execution.

12. The method of claim 11, wherein the detection model is based on a set of model features considered for the categorical prediction, and the method comprises training the detection model by determining one or more regression coefficients based on odds ratio among for respective model features.

13. The method of claim 12, further comprising determining statistical association among respective multi-label predictions for excluding at least one model feature from training the detection model.

14. The method of claim 11, further comprising determining variance inflation factors for generating class weights to associate with respective multi-label predictions.

15. The method of claim 11, wherein the detection model is based on an ordinal regression for determining variance inflation factors.

16. The method of claim 11, wherein the multi-label predictions includes a satisfactory, a require improvement, or an unsatisfactory prediction.

17. The method of claim 11, comprising:
receiving user input representing an audit type;
generating a first set of features based on the set of data records using feature engineering;
transmitting the first set of features to the detection model; and
generating, by the detection model at each respective time stage from the sequence of time stages based on the first set of features, the categorical prediction associated with the data operations using the meta attributes.

18. The method of claim 17, comprising:
receiving a second user input representing a second audit type;
generating a second set of features based on the set of data records using feature engineering;
transmitting the second of features to the detection model; and
generating, by the detection model at each respective time stage from the sequence of time stages based on the second set of features, the categorical prediction associated with the data operations using the meta attributes.

19. The method of claim 18, comprising generating at least one of the first and second set of features using large language model.

20. A non-transitory computer-readable medium or media having stored thereon machine interpretable instructions which, when executed by a processor, cause the processor to perform a computer-implemented method of dynamic data operations modelling, the method comprising:
receiving a set of data records associated with meta attributes representing operations on the data records, the operations performed over a sequence of time stages;
generating, by a detection model at each respective time stage from the sequence of time stages, a categorical prediction associated with the data operations using the meta attributes, the detection model based on a multinomial logistic regression providing the categorical prediction for adapting multi-label predictions; and
transmitting, following the sequence of time stages, one or more signals representing one or more from the categorical predictions for dynamically updating the user interface for communicating an interim categorical prediction during data operations execution.
